(19) United States
(12) Patent Application Publication
(10) Pub. No.: US 2018/0090966 A1
(43) Pub. Date: Mar. 29, 2018

(54) System And Method For Communicating Dynamic Charging Attributes Of A Charging Station

(71) Applicant: FORD GLOBAL TECHNOLOGIES, LLC, DEARBORN, MI (US)

(72) Inventors: JOEY RAY GROVER, MADISON HEIGHTS, MI (US); JUSTIN DICKOW, ROYAL OAK, MI (US)

(21) Appl. No.: 15/277,773

(22) Filed: Sep. 27, 2016

(51) Int. Cl. H02J 7/02; H02J 50/10; H02J 50/80; H04W 4/00

(52) U.S. Cl. CPC H02J 7/025; H04W 4/008; H02J 50/80; H02J 50/10

(57) ABSTRACT

Embodiments include a wireless charging station comprising a power supply having an adjustable power output and configured to wirelessly transfer the power output to an external device having wireless charging capability; and a wireless transceiver configured to advertise a plurality of power values available at the power supply for wirelessly charging the device and to receive, from the device, a request for power at a selected one of the advertised power values. Other embodiments include a method for communicating dynamic charging attributes. The method comprises advertising, using a wireless transceiver, a plurality of power values available from a power supply; receiving, via the wireless transceiver, a request for wireless power transfer in accordance with a selected one of the advertised power values; adjusting a power output of the power supply based on the selected power value; and wirelessly supplying the adjusted power output.

### TECHNICAL FIELD

This application generally relates to charging stations for charging an electrical device and more specifically, to charging systems offering dynamic charging attributes.

### BACKGROUND

Wireless charging, also known as wireless power transfer or inductive charging, enables a power source (e.g., a wireless charging station) to transmit electromagnetic energy to an electrical load (e.g., an electrical or electronic device) through an air gap, without the use of cables or other wires. Due to the convenience and improved user experience provided by this technology, wireless charging has been implemented in a wide range of devices, from low-power toothbrushes to high-power electric vehicles. For example, many smart phones, smart devices (e.g., smart watches), and other mobile devices now have built-in wireless charging capability.

However, many of these devices come with a dedicated wireless charging unit that can only be used to supply power to the corresponding device because of, for example, physical attributes that are tailored to the shape and size of the device and/or static charging attributes (e.g., voltage, amperage, etc.) that are limited to the power requirements of that device. Thus, users of such devices may be forced to carry multiple chargers with them (e.g., in vehicles, briefcases, purses, etc.) and, if the charging unit is ever lost or otherwise unavailable, may have difficulty finding an alternative charger.

Accordingly, there is still a need in the art for a wireless charging unit or station that can dynamically change its power output to match the power requirements of an electrical or electronic device having wireless charging capability.

### SUMMARY

The invention is intended to solve the above-noted and other problems by providing systems and methods for, among other things, communicating dynamic power attributes available at a wireless charging station to electrical or electronic devices having wireless charging capability.

For example, one embodiment provides a wireless charging station comprising a power supply having an adjustable power output and configured to wirelessly transfer the power output to an external device having wireless charging capability; and a wireless transceiver configured to advertise a plurality of power values available at the power supply for wirelessly charging the device and to receive, from the device, a request for power at a selected one of the advertised power values.

Another example embodiment provides a method for communicating dynamic charging attributes. The method comprises advertising, using a wireless transceiver, a plurality of power values available from a power supply; receiving, via the wireless transceiver, a request for wireless power transfer in accordance with a selected one of the advertised power values; adjusting a power output of the power supply based on the selected power value; and wirelessly supplying the adjusted power output.

Another example embodiment provides a vehicle comprising a charging station positioned in a vehicle cabin and configured for wirelessly transferring power to an external battery, the charging station including a power supply having an adjustable power output; and a wireless transceiver for advertising a plurality of power values available for adjusting the power output of the power supply and receiving a request to supply power to the battery at a selected one of the advertised power values.

As will be appreciated, this disclosure is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detail description, and such implementations are intended to within the scope of this application.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is an illustration of an example environment for communicating dynamic charging attributes of a wireless charging station to a rechargeable device having wireless charging capabilities, in accordance with certain embodiments.

FIG. 2 is a flow diagram of example operations implemented by the wireless charging station and the rechargeable device of FIG. 1, in accordance with certain embodiments.

FIG. 3 is an illustration of an example vehicle comprising the wireless charging station of FIG. 1, in accordance with certain embodiments.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

As used therein, the term “wireless charging” can refer to transferring any form of energy associated with electric fields, magnetic fields, electromagnetic fields, or otherwise from a transmitter (or charge-transmitting device) to a receiver (or charge-receiving device) without the use of physical electrical conductors, such that power may be transferred through free space. The power output into a wireless field (e.g., a magnetic or electromagnetic field) may be received, captured by, or coupled by a “receive antenna” in the charge-receiving device to achieve the power transfer. Each of the transmitter and the receiver may include various circuitry for transmitting and receiving power, respectively, and otherwise implementing wireless power transfer between the devices. For example, the transmitter may include an induction coil (e.g., a primary coil) configured to create an alternating electromagnetic field within the transmitter. When the receiver is placed in close proximity to the transmitter, the power emitted by the electromagnetic field may be captured by a second induction coil (e.g., a secondary coil) included in the receiver. Thus, the two induction coils can combine to form an electrical transformer that wirelessly charges a battery coupled to the receiver. As will be appreciated, other techniques may be used for wirelessly transferring power between the transmitter and the receiver and are intended to be covered by the wireless charging techniques described herein.

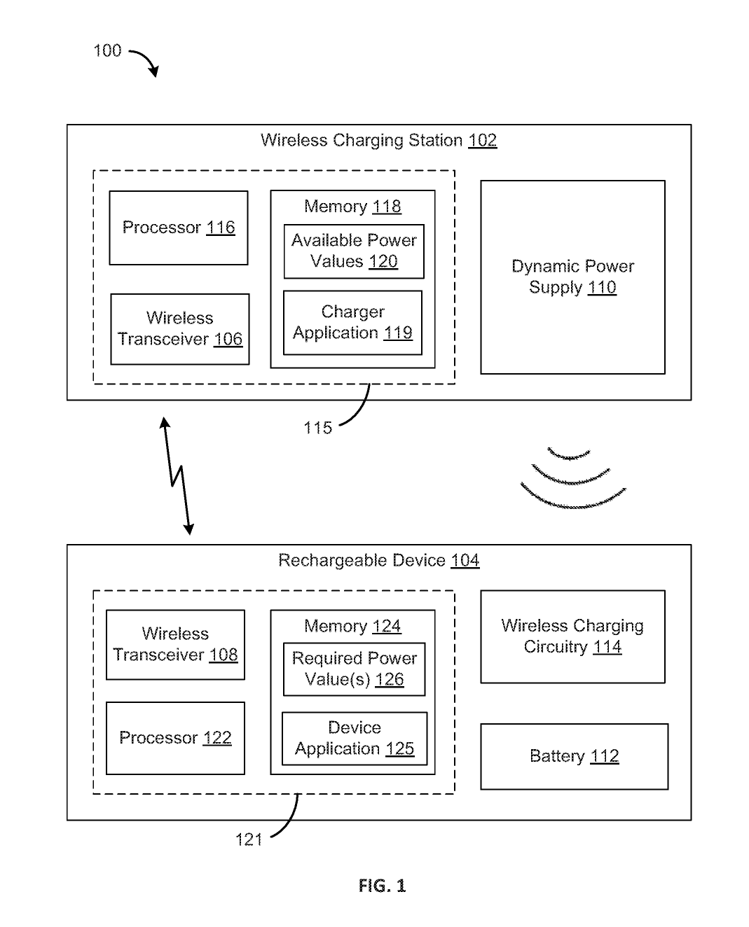

FIG. 1 illustrates an example environment 100 for communicating dynamic charging attributes of a wireless charging station 102 to a rechargeable device 104 having wireless charging capability, in accordance with embodiments. As shown, the wireless charging station 102 includes a wireless transceiver 106 for facilitating communication with the rechargeable device 104 via a wireless transceiver 108 included in the device 104. In embodiments, the wireless transceivers 106 and 108 can be configured to implement a handshaking process for establishing a communication channel between the charging station 102 and the rechargeable device 104. Further, the established communication channel can be used to transfer, between the two components of the environment 100, information associated with the dynamic charging attributes of the charging station 102 and the power requirements of the rechargeable device 104, as described in more detail below. In addition, the charging station 102 can be configured to wirelessly transfer power to the rechargeable device 104 for charging a battery 112 included therein.

The wireless charging station 102 (also referred to herein as a “charging station”) can be any type of charging pad (e.g., a flat pad), wireless charger, a charging base, or other device configured to wirelessly supply power to, or charge, a battery or battery-powered equipment. The charging station 102 can be powered by plugging into a power source, such as, e.g., a wall socket, connecting to a USB outlet of another electronic device (e.g., a laptop, a vehicle, etc.), or coupling with another power source. In addition, the charging station 102 includes a dynamic power supply 110 capable of varying the power output of the charging station 102, so that various devices with different charging attributes can be serviced by the charging station 102. For example, the dynamic power supply 110 may include a regulator or other circuitry for adjusting the voltage and amperage attributes of the power output by the charging station 102 based on the power requirements of the rechargeable device 104 or other power-receiving device.

The rechargeable device 104 can be any type of electrical or electronic device that includes a rechargeable battery 112 or other energy storage device and wireless charging circuitry 114 configured to enable wireless charging of the battery 112. For example, the rechargeable device 104 may be a mobile communication device (e.g., smartphone, tablet, etc.), a consumer electronics device, a personal media device, a gaming device, an e-reader or electronic book, a battery-operated toy, a wearable device, a medical device or instrument, a household appliance, an electric vehicle (e.g., a plug-in hybrid electric vehicle (PHEV), plug-in electric vehicle, or any other type of vehicle that utilizes charging equipment to re-charge a battery of the vehicle), or a battery, itself, that has wireless charging capability. In some embodiments, the wireless charging circuitry 114 may include a receiving coil (not shown) for capturing power emitted by a transmitting coil (not shown) included in the charging station 102, the power being supplied by the dynamic power supply 110 of the charging station 102 and being provided to the battery 112 of the rechargeable device 104. While the environment 100 shown in FIG. 1 depicts only one rechargeable device 104, it should be appreciated that the environment 100 may include multiple rechargeable devices capable of wirelessly receiving power from, and communicating with, the wireless charging station 102.

As shown in FIG. 1, the charging station 102 can further include a computing device 115 (e.g., a microcontroller) comprising a processor 116, a memory 118, and the wireless transceiver 106. The processor 116 may include one or more of a data processor, a microprocessor, a programmable logic array, an application-specific integrated circuit, a logic device, or other electronic device for processing, inputting, outputting, manipulating, storing, or retrieving data. The memory 118 may be an electronic memory, nonvolatile random access memory (e.g., RAM), flip-flops, a computer-writable or computer-readable storage medium, a magnetic or optical data storage device, or other electronic device for storing, retrieving, reading, or writing data. Though not shown, the computing device 115 may include a data bus, one or more input devices, and one or more output devices for facilitating operation of, or communication between, the processor 116, the memory 118, and/or the wireless transceiver 106.

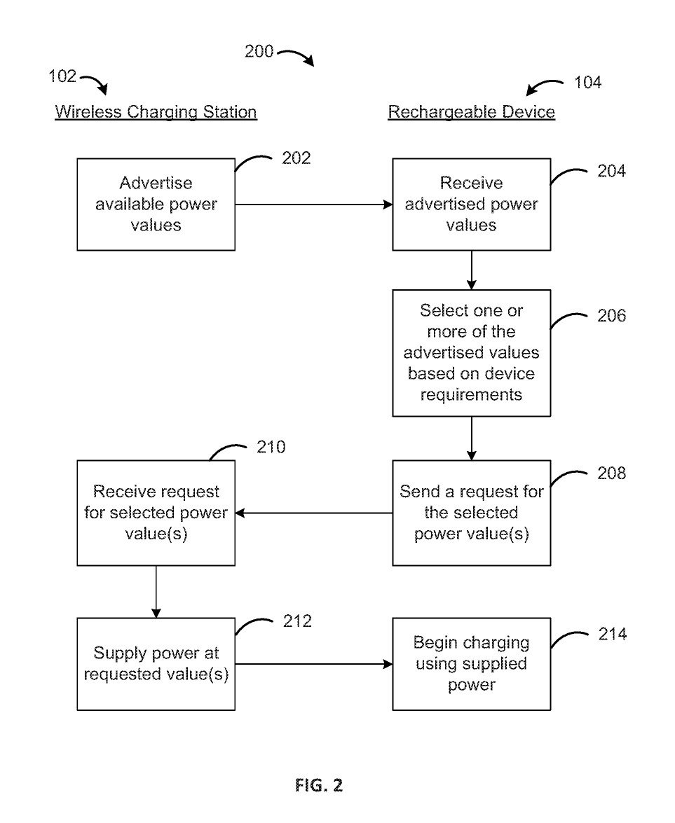

The memory 118 can store one or more software program modules or software instructions, including, for example, a charger application 119, for execution by the processor 116. In embodiments, the charger application 120 comprises computer programming instructions that, when executed by the processor 116, cause the processor 116 to carry out one or more operations associated with the charging station 102 (such as, for example, certain operations included in process 200 shown in FIG. 2). The memory 118 can also store data associated with the wireless charging station 102, such as, for example, the dynamic charging attributes or parameters of the dynamic power supply 110, including, for example, a plurality of power output values 120 that are available for wireless charging purposes from the charging station 102.

In some embodiments, the power output of the dynamic power supply 110 can be modified discretely by selecting between preset parameters that are defined by the power adjustment capabilities of circuitry included in the power supply 110. In such cases, the power values 120 (also referred to herein as “available power values”) can include discrete charging attributes, such as, for example, specific voltage and amperage values. In other embodiments, the power output of the dynamic power supply 110 can be modified to meet any value within a preset range of parameters defined by the power adjustment circuitry included in the power supply 110. In such cases, the available power values 120 can include one or more ranges of charging attributes, such as, for example, a range of voltage values (e.g., 5 V-12 V) and a range of amperage values (e.g., up to 1.5 A).

As shown in FIG. 1, the rechargeable device 104 can further include a computing device 121 (e.g., a microcontroller) comprising a processor 122, a memory 124, and the wireless transceiver 108. The processor 122 may include one or more of a data processor, a microprocessor, a programmable logic array, an application-specific integrated circuit, a logic device, or other electronic device for processing, inputting, outputting, manipulating, storing, or retrieving data. The memory 118 may be an electronic memory, nonvolatile random access memory (e.g., RAM), flip-flops, a computer-writable or computer-readable storage medium, a magnetic or optical data storage device, or other electronic device for storing, retrieving, reading, or writing data. Though not shown, the computing device 121 may include a data bus, one or more input devices, and one or more output devices for facilitating operation of, or communication between, the processor 122, the memory 124, and/or the wireless transceiver 108.

The memory 124 can store one or more software program modules or software instructions, including, for example, a device application 125, for execution by the processor 122. In embodiments, the device application 125 comprises computer programming instructions that, when executed by the processor 122, cause the processor 122 to carry out one or more operations associated with the rechargeable device 104 (such as, for example, certain operations included in process 200 shown in FIG. 2). The memory 124 can also store data associated with the rechargeable device 104, such as, for example, the power parameters or characteristics of the battery 112, including, for example, one or more power values 126 that are required to wirelessly charge the battery 112. The power value(s) 126 (also referred to herein as “required power values”) can include, for example, a specific voltage value and/or a specific amperage value included in a charging profile for the battery 112.

In some cases, one or more of the computing devices 115, 121 can be configured as an after-market product that is added or attached to the corresponding component of the environment 100, for example, after manufacturing. In other cases, one or more of the computing devices 115, 121 can be pre-installed or integrated into the corresponding component of the environment 100, for example, during manufacturing. In such cases, certain components of the computing device 115 or 121 may be configured to perform additional operations of the charging station 102 or rechargeable device 104, respectively, such as, for example, charging-related operations.

The wireless transceiver 106 of the charging station 102 and the wireless transceiver 108 of the rechargeable device 104 can be configured to communicate with each other using one or more types of wireless communication technology, such as, for example, short-range communications technology (e.g., BLUETOOTH®, Zigbee, radio frequency identification (RFID), near field communication (NFC), etc.), wide area network communications technology (e.g., WWAN, Wi-Fi, Wi-Fi Direct, WLAN, etc.), or cellular communications technology (e.g., LTE, LTE-Advanced, GSM, 3G, etc.). In a preferred embodiment, the wireless transceivers 106 and 108 each include a BLUETOOTH Low Energy (BLE) transceiver or other communication device (e.g., a sensor) configured to transmit wireless signals to and receive wireless signals from other BLE sensors and/or other BLE-compatible devices using a 2.4 Gigahertz (GHz) operating band. In some embodiments, one or more of the charging station 102 and the rechargeable device 104 includes a wireless communication module (not shown) comprising the respective wireless transceiver 106, 108, as well as other wireless communication circuitry, such as, for example, antennas, radios, and/or modems, for connecting to, or interfacing with, one or more wireless networks, such as, e.g., a BLE network.

FIG. 2 illustrates an exemplary process 200 comprising operations that may be implemented by one or more of, and/or through interactions between, the charging station 102 and the rechargeable device 104 using software executing on one or more computer processors included in each. In some embodiments, the process 200 may be implemented as two separate methods: a charge-providing method carried out by the computing device 115 of the charging station 102 and a charge-receiving method carried out by the computing device 121 of the rechargeable device 104. Further, the charging station 102 and the rechargeable device 104 may interact with each other to carry out certain operations of each method. For example, the charge-providing method may be implemented, at least in part, by the processor 116 of the charging station 102 executing software stored in the memory 118, such as, for example, the charger application 119. Similarly, the charge-receiving method may be implemented, at least in part, by the processor 122 of the rechargeable device 104 executing software stored in the memory 124, such as, for example, the device application 125. In the following paragraphs, the process 200 will be described in conjunction with the components of the environment 100 for ease of explanation.

The process 200 may begin at step 202, wherein the wireless charging station 102 advertises the power values 120 available for charging purposes at the charging station 102. In embodiments, the step 202 can be carried out by the processor 116 of the charging station 102 instructing the wireless transceiver 106 to transmit a wireless signal (e.g., beacon) comprising the available power values 120. The processor 116 may generate the wireless signal after retrieving the power values 120 from the memory 118. The wireless transceiver 206 can be configured to periodically transmit the wireless signal within a predefined wireless communication range (e.g., up to 50 meters), and any device located within that range and capable of communicating with the wireless transceiver 106 may receive the advertising signal. In a preferred embodiment, the wireless signal is advertised using BLE technology.

At step 204, the rechargeable device 104 receives the power values 120 advertised by the charging station 102. In embodiments, the step 204 can be carried out by the wireless transceiver 108 of the rechargeable device 104 detecting the wireless signal transmitted by the wireless transceiver 106 of the charging station 102 and providing the wireless signal, or the available power values 120 included therein, to the processor 122 of the rechargeable device 104. In some embodiments, the steps 202 and 204 may constitute a handshaking procedure for establishing communication between the charging station 102 and the rechargeable device 104. In some cases, the process 200 may include additional authentication steps (not shown) for verifying an identity of the charging station 102 as a valid charging station and/or an identity of the rechargeable device 104 as a valid device in need of wireless charging.

At step 206, the rechargeable device 104 selects one or more of the advertised power values 120 based on the power requirements of the device 104. In embodiments, the step 206 can be carried out, at least in part, by the processor 122 of the rechargeable device 104 retrieving the one or more required power values 126 from the memory 124 and comparing the retrieved value(s) 126 with the available power values 120 advertised by the charging station 120. If the advertised values 120 include a match for, or encompass, the one or more power values 126 required for charging the battery 112 of the rechargeable device 104, the processor 122 may select the corresponding value(s) (e.g., voltage and/or amperage values) from the list of available power values 120. For example, if the advertised power values 120 include 5V, 9V, and 12V, and the required power value 126 is 5V, the processor 122 will select 5V from the list of values 120. As another example, if the advertised power values 120 include a range of up to 1.5 A, and the required power value 126 is 1 A, the processor 122 will select 1 A from the advertised power values 120. If, on the other hand, the advertised power values 120 do not include the required power value 126, the process 200 may end after step 204 and communication between the rechargeable device 104 and the charging station 102 may be terminated.

At step 208, the rechargeable device 104 sends a request to the charging station 102 for a wireless power transfer in accordance with the one or more power values selected from the advertised power values 120. In embodiments, the step 208 can be carried out by the processor 122 generating a message that includes the power value(s) selected at step 206 and/or a request for the charging station 102 to supply power at those specifications, and providing the message to the wireless transceiver 108 of the rechargeable device 104 for transmission to the charging station 102.

At step 210, the charging station 102 receives the request for wireless power transfer in accordance with selected power value(s) from the rechargeable device 104. In embodiments, the step 210 can be carried out by the wireless transceiver 106 of the charging station 102 receiving the message (or wireless signal) transmitted by the rechargeable device 104 at step 208 and providing the selected power value and/or the request for power to the processor 122.

At step 212, the charging station 102 supplies power to the rechargeable device 104 in accordance with the power value request received from the rechargeable device 104. In embodiments, the step 212 can be carried out by the processor 122 adjusting one or more parameters of the dynamic power supply 110 to produce an adjusted power output having the requested power value(s) (e.g., voltage and/or amperage values), or instructing the dynamic power supply 110 to adjust its power output to match the requested power value(s). For example, the dynamic power supply 110 may adjust its power output by changing the voltage that is generated across a primary induction coil included therein. The step 212 can further include the dynamic power supply 110 generating a wireless (e.g., magnetic or electromagnetic) field for wirelessly transferring power to the rechargeable device 104 in accordance with the requested power requirements.

At step 214, the rechargeable device 104 begins wirelessly charging the battery 112 using the power supplied by the charging station 102. In embodiments, the step 214 can be carried out by the wireless charging circuitry 114 capturing the power output by the charging station 102 and providing the power to the battery 112 for replenishing a charge of the battery 112. For example, the wireless field emitted by the charging station 102 may cause a voltage to be generated across a secondary induction coil included in the wireless charging circuitry 114, the generated voltage matching the power value requested by the rechargeable device 104. The process 200 may end once the battery's charge has been replenished. For example, the rechargeable device 104 may terminate the wireless connection with the charging station 102 and/or instruct the wireless charging circuitry 114 to stop receiving power from the charging station 102.

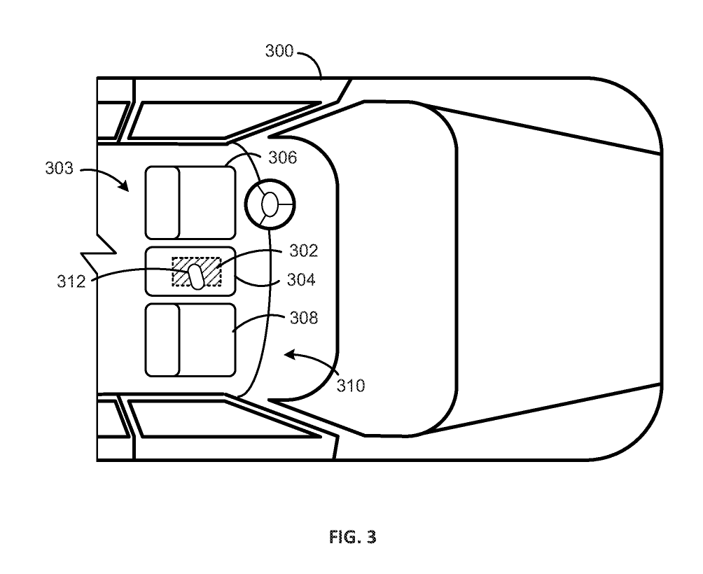

FIG. 3 illustrates an example implementation of the charging station 102 shown in FIG. 1 and described herein. In particular, FIG. 3 depicts a vehicle 300 comprising a wireless charging station 302 for wirelessly transferring power to one or more rechargeable devices (not shown) while in the vehicle 300, in accordance with embodiments. The wireless charging station 302 may be similar to the charging station 102 shown in FIG. 1 and described herein. In some embodiments, the wireless charging station 302 may be a pad or sheet shaped and sized to fit a designated flat surface of the vehicle 300. The wireless charging station 302 may be placed anywhere within a cabin area 303 of the vehicle 300 that provides a driver and/or passenger of the vehicle 300 with easy access to the charging station 302. For example, in the illustrated embodiment, the wireless charging station 302 is located on or within a center console 304 positioned between a front driver seat 306 and a front passenger seat 308. In other embodiments, the wireless charging station 302 may be placed on or within a dashboard 310 of the vehicle 300.

In embodiments, the process 200 may be carried out within the vehicle 300. For example, the charging station 302 may advertise the dynamic charging attributes or power values available for charging purposes at the charging station 302 (e.g., according to step 202 of FIG. 2). Once the user places a device 312 having wireless charging capability (such as, e.g., the rechargeable device 104 shown in FIG. 1) on or near the charging station 302, the device may receive the advertised power values (e.g., according to step 204 of FIG. 2), select one of the advertised power values based on its own power requirements (e.g., according to step 206 of FIG. 2), and send a request for charging at the selected power value back to the charging station 302 (e.g., according to step 208 of FIG. 2). The charging station 302 may receive the request (e.g., according to step 210 of FIG. 2) and supply power to the device 312 at the requested power value (e.g., according to step 212 of FIG. 2). The device 312 may then begin charging its battery using the power output by the charging station 302 (e.g., according to step 214 of FIG. 2).

In certain embodiments, the process descriptions or blocks in the figures, such as FIG. 2, can represent modules, segments, or portions of code which include one or more executable instructions for implementing specific logical functions or steps in the process. Any alternate implementations are included within the scope of the embodiments described herein, in which functions may be executed out of order from that shown or discussed, including substantially concurrently or in reverse order, depending on the functionality involved, as would be understood by those having ordinary skill in the art.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

1. A wireless charging station, comprising:
a power supply having an adjustable power output and configured to wirelessly transfer the power output to an external device having wireless charging capability; and
a wireless transceiver configured to advertise a plurality of power values available at the power supply for wirelessly charging the device and to receive, from the device, a request for power at a selected one of the advertised power values.

2. The wireless charging station of claim 1, further comprising a memory for storing the plurality of power values.

3. The wireless charging station of claim 1, further comprising a processor for adjusting one or more attributes of the power supply to produce an adjusted power output having the selected power value requested by the device.

4. The wireless charging station of claim 1, wherein the wireless transceiver includes a BLUETOOTH Low Energy (BLE) transceiver.

5. The wireless charging station of claim 1, wherein the plurality of power values includes a range of values.

6. The wireless charging station of claim 1, wherein the plurality of power values includes discrete values.

7. The wireless charging station of claim 1, wherein the plurality of power values includes at least one of voltage values or amperage values.

8. A method for communicating dynamic charging attributes, comprising:
advertising, using a wireless transceiver, a plurality of power values available from a power supply;
receiving, via the wireless transceiver, a request for wireless power transfer in accordance with a selected one of the advertised power values;
adjusting a power output of the power supply based on the selected power value; and
wirelessly supplying the adjusted power output.

9. The method of claim 8, wherein advertising the plurality of power values includes periodically transmitting a wireless signal comprising the plurality of power values using BLUETOOTH Low Energy (BLE) communications technology.

10. The method of claim 8, wherein adjusting the power output of the power supply includes adjusting one or more parameters of the power supply to produce an adjusted power output having the selected power value.

11. The method of claim 8, wherein wirelessly supplying the adjusted power output includes wirelessly transferring the adjusted power output to a rechargeable battery included in a device having wireless charging capability.

12. The method of claim 8, wherein the plurality of power values includes a range of values.

13. The method of claim 8, wherein the plurality of power values includes discrete values.

14. A vehicle, comprising:
a charging station positioned in a vehicle cabin and configured for wirelessly transferring power to an external battery, the charging station including:
a power supply having an adjustable power output; and
a wireless transceiver for advertising a plurality of power values available for adjusting the power output of the power supply and receiving a request to supply power to the battery at a selected one of the advertised power values.

15. The vehicle of claim 14, wherein the charging station further includes a memory for storing the plurality of power values.

16. The vehicle of claim 14, wherein the charging station further includes a processor for adjusting one or more attributes of the power supply to produce an adjusted power output having the selected power value.

17. The vehicle of claim 14, wherein the charging station is positioned in a center console of the vehicle cabin.

18. The vehicle of claim 14, wherein the charging station is a substantially flat pad.

19. The vehicle of claim 14, wherein the wireless transceiver includes a BLUETOOTH Low Energy (BLE) transceiver.

20. The vehicle of claim 14, wherein the plurality of power values includes at least one of voltage values or amperage values.
